(19) United States
(12) Patent Application Publication
(10) Pub. No.: US 2011/0081981 A1
(43) Pub. Date: Apr. 7, 2011

(54) SPEED DETECTOR AND SWING TOOL HAVING THE SAME

(75) Inventor: Hiroshi OKAMOTO, Ebina-shi (JP)

(73) Assignee: SEIKO EPSON CORPORATION, Tokyo (JP)

(21) Appl. No.: 12/896,326

(22) Filed: Oct. 1, 2010

(30) Foreign Application Priority Data
Oct. 6, 2009 (JP) 2009-232872
Jul. 27, 2010 (JP) 2010-167783

(51) Int. Cl. A63B 69/36; G01L 13/02

(52) U.S. Cl. 473/233; 73/716

(57) ABSTRACT

A speed detector includes: a pressure sensor including a pitot tube attached to a moving body in a state in which an air inlet hole is directed toward a direction of a movement of the moving body, a diaphragm having a pressure receiving surface displaced by pressure, and a pressure-sensitive section adapted to receive force caused by the displacement to detect the pressure, the pressure sensor being disposed to the moving body and detecting the pressure caused in the pitot tube; and an operation section adapted to detect a speed of the moving body based on the difference between the pressure at rest and the pressure in movement of the moving body, wherein the pressure sensor is disposed so that a normal line of the pressure receiving surface becomes perpendicular to the direction of the movement.

### BACKGROUND

1. Technical Field

The present invention relates to a speed detector, and in particular to a speed detector composed mainly of a pitot tube and a pressure sensor, and attached to a SWING tool, and the SWING tool attached with the speed sensor.

2. Related Art

In ball sports such as golf, baseball, or tennis, practice swings and stroke practices with a golf club, a bat, or a tennis racket are extremely important for upskilling, and therefore, sport persons and athletes practice with practice swings night and day. Further, in the practice with practice swings, how the stroke skill is improved is often determined by objectively measuring the speed of the swing.

FIGS. 7A and 7B show a speed measuring device according to JP-A-63-105777 (Document 1) as a first related-art example. FIG. 7A is a diagram showing a form of use of the speed measuring device, and FIG. 7B is a detail diagram of the speed measuring device. In Document 1, there is disclosed a speed measuring device 100 having a pitot tube 104, a pressure sensor 106 for detecting the pressure generated in the pitot tube 104, an arithmetic section 116 for performing an operation on the signal of the pressure sensor 106 to thereby obtain a swing speed, and a display section 118 for displaying the result of the arithmetic operation, and incorporated in a stroke tool (a bat) 102.

In the stroke tool according to Document 1, when swinging the stroke tool, a relative speed movement occurs between the air and the stroke tool, and as a result, from a viewpoint of the stroke tool, the air flows at the same speed as the movement speed of the stroke tool in the opposite direction to the direction thereof. It is attempted that the swing speed of the stroke tool is obtained by measuring the flow rate of the air. Further, in Document 1, the pitot tube 104 is used for measuring the flow rate of the air. In the case of attaching the pitot tube 104 to the stroke tool, when swinging the stroke tool (the bat) 102, the pressure caused by the flow of the air is applied to the pitot tube 104 having an opening toward the direction of the movement, and then the pressure is detected by the pressure sensor 106. The swing speed of the stroke tool can be obtained by converting the flow of the air into the flow rate using the detection signal. In Document 1, the form of embedding the speed measuring device 100 in the bat 102 is adopted, wherein the pitot tube 104 is attached so as to be exposed toward the direction of the movement of the bat, and the pressure sensor 106 and a pressure correction sensor 110 having the normal line of the pressure receiving surfaces of diaphragms 108, 112 directed toward the direction of the movement, a temperature sensor 114 for measuring the temperature used for temperature compensation of the pressure sensor 106 and the pressure correction sensor 110, the arithmetic section 116, and the display section 118 are embedded in the bat 102.

FIGS. 8A and 8B show a head speed measuring device according to JP-A-2008-246139 (Document 2) as a second related-art example. FIG. 8A is a diagram showing a form of use of the head speed measuring device, and FIG. 8B is a block diagram of the head speed measuring device. In Document 2, there is disclosed a configuration of arranging a head speed measuring device 200 so as to be able to measure the speed of the golf head 216 when passing through the vicinity of the lowest point of the movement locus K of the golf head 216, the head speed measuring device 200 including a microwave Doppler sensor 202, an amplifier 204 for amplifying the output signal from the Doppler sensor 202, a comparator 206 for comparing the signal amplified by the amplifier 204 with a reference value to thereby output a Doppler pulse, a micro-controller 208 for receiving the signal output from the comparator 206 and obtaining the swing speed, a display section 210 for displaying the swing speed and so on under the control of the micro-controller 208, and a switch group 212 connected to the micro-controller 208.

According to the configuration described above, since the speed of the golf head 216 of the golf club 214, which hits the ball B, is measured by applying pulsed light with a light axis L to the golf head 216 when passing through the vicinity of lowest point, and then obtaining the difference between the pulsed light reflected by the golf head 216 and having the frequency varied due to the Doppler effect and the reference pulse, it is possible to measure the swing speed contactlessly with the golf head 216.

FIGS. 9A and 9B show a long-putting practice device according to JP-A-2006-158893 (Document 3) as a third related-art example. FIG. 9A is an overall schematic diagram, FIG. 9B is a block diagram of a unit constituting the long-putting practice device. In Document 3, there is disclosed a long-putting practice device 300 having a thin plate-like magnet 304 with a predetermined width bonded to the bottom surface of a putter head 302 for hitting a ball, a unit 308 collectively including a magnetic sensor 310, a CPU arithmetic processing circuit 312, a display circuit 314, a power supply circuit 316, and so on disposed on a green simulated mat 306, thereby detecting the speed of the putter head 302. Thus, the magnetic field generated from the thin plate-like magnet 304 moves with the putter head 302, and the speed of the putter head 302 is calculated using the time period required for the magnetic field to pass above the magnetic sensor 310. Therefore, similarly to the case of Document 2, the speed of the putter head 302 can be measured in a contactless manner.

However, in Document 1, the pressure correction sensor 110 and the correction process using it for correcting the acceleration of the bat 102 in the direction of the movement are required, which causes a problem of further increasing the number of components to increase in cost. In Documents 2 and 3, since the measurement is performed in a contactless manner, misalignment is caused between the measurement direction and the direction in which the golf club or the putter is swung, which causes an error in the swing speed thus measured. Further, in Document 3, there arises a problem that a variation is caused in the detected speed of the putter head 302 due to the variation in the height of the thin plate-like magnet attached to the putter head 302 when passing above the magnetic sensor 310, the variation in the height depending on the skill of the player.

### SUMMARY

An advantage of some aspects of the invention is to provide a speed detector with a suppressed variation in measurement while achieving a simple configuration, and a SWING tool equipped with the speed detector.

The invention can solve at least a part of the problem described above, and can be embodied as the following application examples.

### APPLICATION EXAMPLE 1

According to this application example of the invention, there is provided a speed detector including a pressure sensor including a pitot tube attached to a moving body in a state in which an air inlet hole is directed toward a direction of a movement of the moving body, a diaphragm having a pressure receiving surface displaced by the pressure, and a pressure-sensitive section adapted to receive force caused by the displacement to detect the pressure, the pressure sensor being disposed to the moving body and detecting the pressure caused in the pitot tube, and an operation section adapted to detect a speed of the moving body based on the difference between the pressure at rest and the pressure in movement of the moving body, wherein the pressure sensor is disposed so that a normal line of the pressure receiving surface becomes perpendicular to the direction of the movement.

According to the configuration described above, since the speed of the moving body can be detected by a single pressure sensor, and at the same time, the normal line of the pressure receiving surface of the diaphragm is arranged to be perpendicular to the direction of the movement of the moving body, even if the acceleration occurs in the direction of the movement, no displacement of the pressure receiving surface is caused by the acceleration, and therefore, the pressure sensor can be prevented from falsely detecting the acceleration in the direction of the movement as the pressure.

### APPLICATION EXAMPLE 2

According to this application example of the invention, there is provided a speed detector including a container attached to a moving body and having an opening section, a first pressure sensor disposed inside the container and including a pitot tube attached to the opening section in the state of having an air inlet hole directed toward a direction of a movement of the moving body to form an internal space integrally with the container, and having pressure in the internal space vary due to the movement of the moving body, a diaphragm having a pressure receiving surface displaced by the pressure, and a pressure-sensitive section adapted to receive force caused by the displacement to detect the pressure, a second pressure sensor disposed outside the internal space, and a second operation section adapted to detect a speed of the moving body based on a difference between the pressure detected by the first pressure sensor and the pressure detected by the second pressure sensor, wherein the first and the second pressure sensors are disposed so that a normal line of the pressure receiving surface becomes perpendicular to the direction of the movement.

According to the configuration described above, it results that the pressure ((static pressure)+(dynamic pressure)) measured by the first pressure sensor and the pressure (static pressure) measured by the second pressure sensor are calculated simultaneously to calculate the dynamic pressure based on the difference between the both parties, and the speed of the moving body is obtained based on the dynamic pressure thus obtained. Therefore, the speed of the moving body can be measured without previously measuring the static pressure.

### APPLICATION EXAMPLE 3

According to this application example of the invention, in the speed detector of Application Example 1 or 2 of the invention, the pitot tube has a tapered shape having a diameter decreasing toward the direction of the movement.

According to the configuration described above, the turbulent flow of the air due to the pitot tube can be prevented outside the pitot tube to thereby reduce the interference to the movement of the moving body.

### APPLICATION EXAMPLE 4

According to this application example of the invention, in the speed detector of either one of Application Examples 1 to 3 of the invention, the moving body receives acceleration in a direction perpendicular to the direction of the movement, and the pressure sensor is disposed so that the normal line of the pressure receiving surface becomes perpendicular to the direction of the acceleration.

As the movement of receiving the acceleration in the direction perpendicular to the direction of the movement of the moving body, a circular movement can be cited, for example. Therefore, according to the configuration described above, it becomes possible to prevent the false detection of the acceleration caused when the moving body performs the circular movement as the pressure to thereby measure the speed of the moving body with high accuracy.

### APPLICATION EXAMPLE 5

According to this application example of the invention, in the speed detector of any one of Application Examples 1, 3 and 4 of the invention, the moving body stops at a measured point for a predetermined period of time, and then moves so as to pass through the measured point, and the operation section calculates the speed of the moving body based on a difference between the pressure the pressure sensor detects when the moving body stops at the measured point for the predetermined period of time, and the pressure the pressure sensor detects when the moving body is in movement.

In the configuration described above, the pressure sensor detects only the static pressure when the moving body is at rest, while it detects the sum of the static pressure and the dynamic pressure when the moving body is in movement. Further, the pressure measured by the pressure sensor has the value varying in accordance with the atmospheric pressure when the heightwise position of the pressure sensor varies. However, the static pressure is equal as long as the moving body stays at the same height. Therefore, if the difference between the pressure in movement and the pressure at rest of the moving body is calculated at the measured point, the component of the dynamic pressure of the moving body can be extracted, and thus the speed of the moving body can be obtained. For example, in the case in which the speed of the moving body becomes the highest, the peak value of the pressure the pressure sensor detects is detected, and the difference between the peak value and the pressure value at rest is calculated, thereby obtaining the speed of the moving body. Further, in the case in which the ball is disposed at the measured point, the pressure value the pressure sensor detects at the moment the moving body actually hit the ball becomes discontinuous. Therefore, by calculating the difference between the pressure value at a time point prior to the moment the pressure becomes discontinuous and the pressure at rest described above, the speed of the moving body can be obtained.

### APPLICATION EXAMPLE 6

According to this application example of the invention, there is provided a SWING tool having the speed detector according to any one of Application Examples 1 to 5 of the invention attached.

According to the configuration described above, the SWING tool capable of calculating the speed of the moving body without being affected by the acceleration acting on the moving body.

### BRIEF DESCRIPTION OF THE DRAWINGS

The invention will be described with reference to the accompanying drawings, wherein like numbers reference like elements.

FIGS. 1A through 1C are schematic diagrams showing a speed detector and a SWING tool attached with the speed detector according to a first embodiment, wherein FIG. 1A is a schematic diagram showing the case in which the speed detector attached to the SWING tool, FIG. 1B is a schematic diagram showing an internal configuration of the speed detector, and FIG. 1C is a cross-sectional view of a pressure sensor constituting the speed detector.

FIGS. 2A and 2B are schematic diagrams showing the speed detector and the SWING tool attached with the speed detector according to the first embodiment, wherein FIG. 2A is a schematic diagram of a stroke tool attached with the speed detector viewed from the direction of the movement, and FIG. 2B is a partial detail diagram of the area surrounded by a broken line shown in FIG. 2A, and at the same time a cross-sectional diagram along the line A-A′ shown in FIG. 1A.

FIG. 3 is a diagram showing the acceleration acting on a diaphragm.

FIGS. 4A through 4C are diagrams showing a procedure of converting an oscillation frequency into pressure in an operation section of the first embodiment, wherein FIG. 4A is a table showing relationships (at measuring temperature of 30° C.) between the pressure, the frequency, and a normalized frequency, FIG. 4B is a plot chart showing the relationship between the pressure and the frequency, and FIG. 4C is a chart showing dots representing the relationship between the pressure and the frequency fitted with a polynomial expression.

FIGS. 5A and 5B are graphs showing the pressure and the speed of the moving body calculated and then displayed by the operation section of the first embodiment, wherein FIG. 5A is a graph showing the pressure measured in the operation section 28, and FIG. 5B is a graph showing the speed of the moving body (a golf head 12d) calculated based on the pressure thus measured.

FIG. 6 is a schematic diagram of a speed detector according to a second embodiment.

FIGS. 7A and 7B are schematic diagrams of a speed measuring device according to a first related art example, wherein FIG. 7A is a diagram showing a form of use of the speed measuring device, and FIG. 7B is a detail diagram of the speed measuring device.

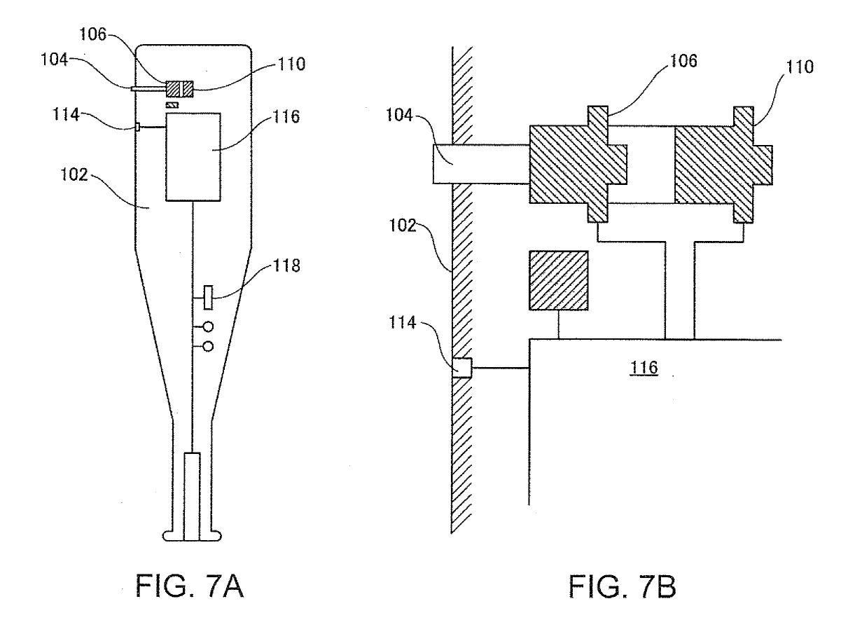

FIGS. 8A and 8B are schematic diagrams of a head speed measuring device according to a second related art example, wherein FIG. 8A is a diagram showing a form of use of the head speed measuring device, and FIG. 83 is a block diagram of the head speed measuring device.

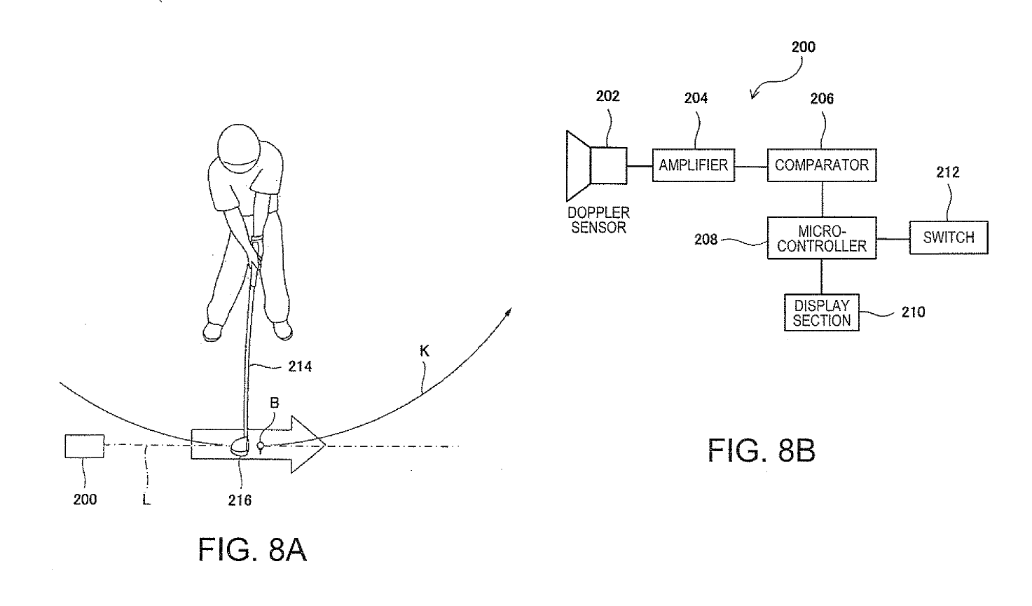

FIGS. 9A and 93 are schematic diagrams of a long-putting practice device according to a third related art example, wherein FIG. 9A is an overall schematic diagram, and FIG. 9B is a block diagram of a unit constituting the long-putting practice device.

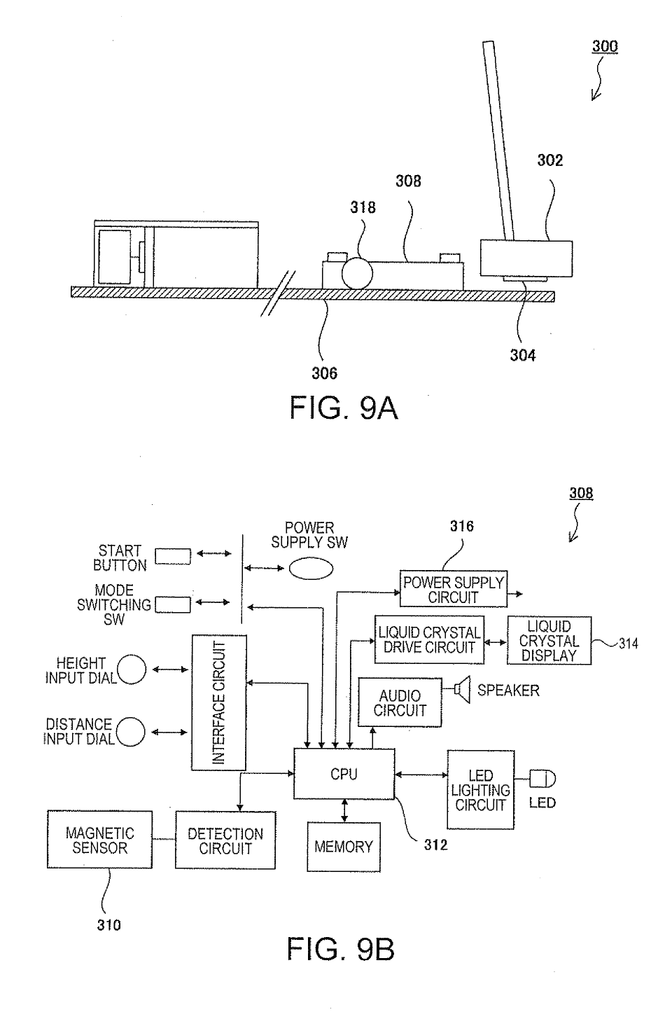

### DESCRIPTION OF EXEMPLARY EMBODIMENTS

Hereinafter, preferred embodiments of the invention illustrated in the accompanying drawings will be explained in detail. It should be noted that constituents, types, combinations, shapes, relative arrangements thereof, and so on described in the present embodiment are not intended to limit the scope of the invention only thereto and nothing more than mere explanatory examples unless specifically described.

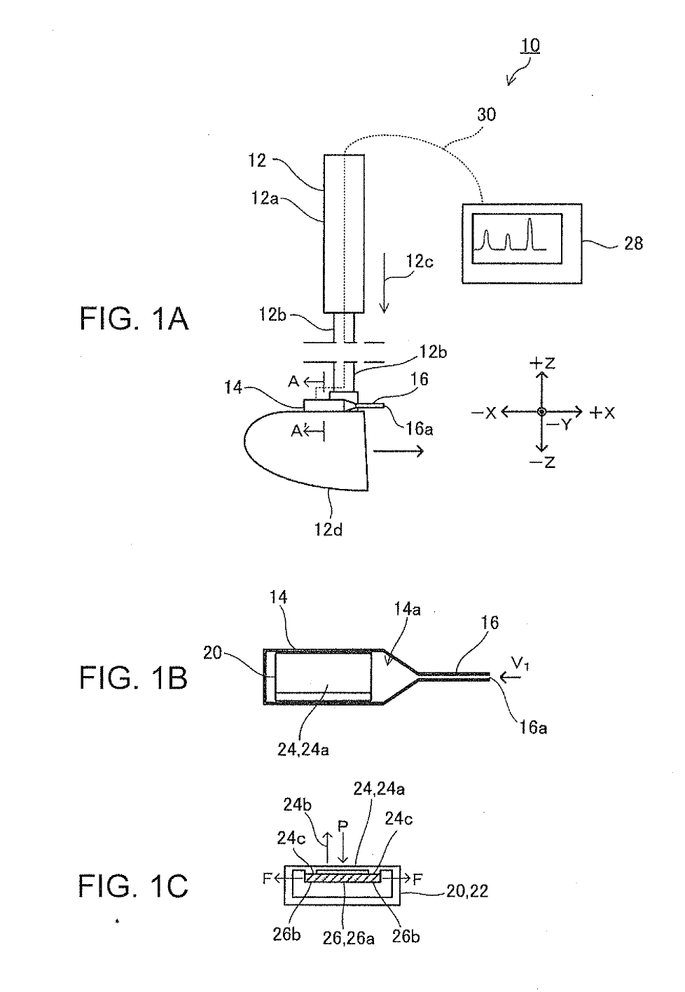

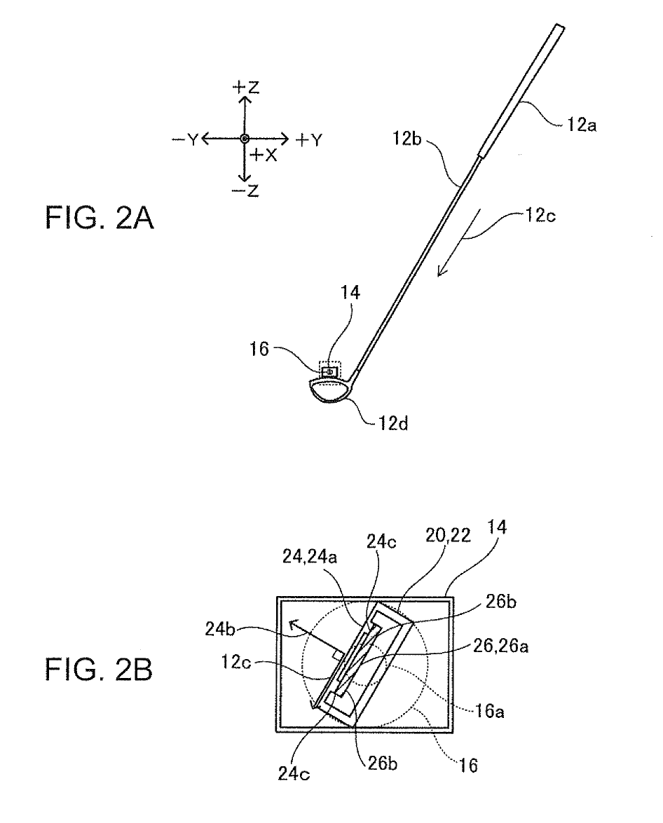

FIGS. 1A through 1C, 2A, and 2B show a speed detector and a SWING tool attached with the speed detector according to the first embodiment. FIG. 1A is a schematic diagram of the case in which the speed detector is attached to a golf club as the SWING tool, FIG. 1B is a schematic diagram showing an internal configuration of the speed detector, FIG. 1C is a cross-sectional view of a pressure sensor constituting the speed detector, FIG. 2A is a schematic diagram of the golf club attached with the speed detector viewed from the direction of the movement, and FIG. 2B is a partial detail diagram of the area surrounded by the broken line shown in FIG. 2A, and at the same time a cross-sectional diagram along the line A-A′ shown in FIG. 1A. The speed detector according to the first embodiment has a pressure sensor 20 provided with a pitot tube 16 attached to a moving body (a golf head 12d) in the state in which an air inlet hole 16a is directed to toward the direction of the movement of the moving body, a diaphragm 24 having a pressure receiving surface 24a displaced by the pressure, and a pressure-sensitive section 26 for receiving the force due to the displacement to detect the pressure, and disposed in the moving body to detect the pressure generated in the pitot tube 16, and an operation section 28 for detecting the speed of the moving body based on the difference between the pressure when the moving body stops and the pressure when the moving body is moving, wherein the pressure sensor 20 is arranged so that the normal line 24b of the pressure receiving surface 24a becomes perpendicular to the direction of the movement.

Further, the moving body (the golf head 12d) moves so that the acceleration (centrifugal force) in the direction perpendicular to the direction of the movement acts on the moving body, and at the same time, the pressure sensor 20 is arranged so that the normal line 24b of the pressure receiving surface 24a becomes perpendicular to the direction of the acceleration.

Further, the moving body constitutes a striking section (a golf head 12d) of the SWING tool (the golf club 12), which rests at the lowest point for a predetermined period of time and is then swung so as to pass through the lowest point, and the operation section 28 calculates the speed of the moving body based on the difference between the pressure the pressure sensor 20 detects when the moving body rests at the lowest point for a predetermined period of time and the pressure at a characteristic point the pressure sensor 20 detects while the moving body is moving.

Hereinafter, description will be provided assuming that the SWING tool to be attached with the speed detector 10 according to the present embodiment is the golf club 12. Therefore, it is assumed in the present embodiment that the moving body is the golf head 12d as the striking section of the golf club 12 for a ball, and speed detector 10 according to the present embodiment is attached to an upper part thereof.

As shown in FIGS. 1A through 1C, the speed detector 10 according to the first embodiment has a container 14 attached to the golf head 12d, the pitot tube 16 attached to the container 14, and a pressure sensor 20 installed in the container 14, and further has the operation section 28 for calculating the speed of the golf head 12d externally.

The pitot tube 16 has a hollow shape, and has an air inlet hole 16a at the tip thereof. Further, the other end thereof on the opposite side to the tip in the longitudinal direction is connected to an opening section 14a. Therefore, the pitot tube 16 is attached to the golf head 12d via the container 14. Further, the pitot tube 16 and the container 14 integrally form an internal space 18, and as a result the pressure of the internal space 18 varies in accordance with the dynamic pressure of the air (at a relative speed V₁) flowing into the air inlet hole 16a due to the movement of the pitot tube.

Now, denoting the pressure of the internal space when the relative speed of the air flowing into the air inlet hole 16a of the pitot tube 16 is V₁ as P₁, the pressure thereof when the relative speed is V₂ as P₂, and the density of the air as ρ, the following relationship is satisfied from the Bernoulli's theorem.

$$\frac{{V}_{1}^{2}}{2} + \frac{{P}_{1}}{ρ} = \frac{{V}_{2}^{2}}{2} + \frac{{P}_{2}}{ρ}$$

In the present embodiment, the speed of the golf head 12d is calculated using the pressure the pressure sensor 20 detects when the golf head 12d rests and the pressure the pressure sensor detects while the golf head 12d is moving. Therefore, denoting the relative speed of the air while the golf head 12d is moving as V₁, and the relative speed of the air during rest as V₂, and assuming that the relative speed V₂ is equal to zero, the relative speed V₁ can be obtained as follows.

$${V}_{1} = k \sqrt{\frac{2 ( {P}_{1} - {P}_{2} )}{ρ}}$$

Here, “k” denotes a pitot tube coefficient, which is a factor depending on the mounting angle and the shape. Therefore, the pressure difference P1-P2 becomes dynamic pressure, and by calculating the pressure difference, the speed of the golf head 12d can be obtained.

Further, in the present embodiment, the pitot tube 16 is formed to have a tapered shape tapering toward the direction (direction of the swing) of the movement of the golf head 12d. Thus, it becomes possible to prevent the turbulent flow of the air due to the movement of the pitot tube 16 from occurring to thereby reduce the interference to the movement of the golf head 12d.

As shown in FIG. 1C, the pressure sensor 20 has a housing 22, a diaphragm 24 forming a part of the housing 22 and having a pressure receiving surface displaced in accordance with the pressure, and the pressure-sensitive section 26 disposed inside the housing 22 and for receiving the force due to the displacement of the pressure receiving surface 24a of the diaphragm 24 to thereby detect the pressure, and has the housing 22 be airtightly sealed to form a vacuum therein to thereby measure absolute pressure based on vacuum.

Flexural deformation inward of the housing 22 is caused by the external pressure in the pressure receiving surface 24a of the diaphragm 24. Further, inside the diaphragm 24 there are disposed a pair of support sections 24c.

The pressure-sensitive section 26 has a vibrating arm 26a of a double tuning-fork type or a single beam type, a pair of base sections 26b coupled to the both ends of the vibrating arm 26a, and sets the detection axis for detecting the force to the direction of a line connecting the pair of base sections 26b. The respective base sections 26b are fixed to the support sections 24c formed inside the diaphragm 24, and thus supported. Further, the vibrating arms 26a are each provided with an excitation electrode (not shown), and by externally applying an alternating-current voltage to the excitation electrodes (not shown), the vibrating arm 26a vibrates at a predetermined resonant frequency.

As shown in FIG. 1C, when the pressure P is applied to the diaphragm 24, the flexural deformation inward of the housing 22 is caused in the pressure receiving surface 24a in accordance with the strength of the pressure P, and at the same time, the distance between the support sections 24c increases in accordance with the strength of the pressure P. Therefore, since the tensile stress F corresponding to the strength of the pressure P acts on the vibrating arm 26a, the resonant frequency of the vibrating arm 26a rises in accordance with the strength of the pressure P. In other words, since internal stress is caused in the vibrating arm 26a in accordance with the pressure thus received, and the resonant frequency varies in accordance with the internal stress, it becomes possible for the pressure sensor 20 to detect the pressure, and thus measuring the pressure. It should be noted that since in the inside of the pressure sensor 20 vacuum is taken as a reference, in the case in which the outside is also in a vacuum state similar to the inside of the housing 22, there is no chance that pressure acts on the pressure receiving surface 24a of the diaphragm 24, and therefore, no internal stress occurs in the vibrating arm 26a.

Incidentally, flexural deformation is also caused in the pressure receiving surface 24a of the diaphragm 24 not only by pressure but also by acceleration. Since the golf club 12 as an application object of the speed detector 10 according to the present embodiment has a shape obtained by connecting a grip 12a, a shaft 12b, and the golf head 12d in series, and the motion of swinging the golf head 12d around the grip 12a is performed, not only the acceleration in the direction of the movement but also the acceleration (centrifugal force) in the direction perpendicular to the direction of the movement act on the golf head 12d, as a result.

Therefore, in the present embodiment, it is required to arrange the pressure sensor 20 so that the normal line 24b of the pressure receiving surface 24a of the diaphragm 24 becomes perpendicular to the directions of the two kinds of acceleration described above. In the SWING with the golf club 12, since the acceleration (the centrifugal force) acts in the substantially longitudinal direction of the shaft 12b of the golf club 12, it is required to arrange the pressure sensor so that the normal line 24b of the pressure receiving surface 24a becomes perpendicular to both of the direction (the direction of the swing, +X direction in FIG. 2A) of the movement of the golf head 12d and the longitudinal direction 12c of the shaft 12b as shown in FIG. 23.

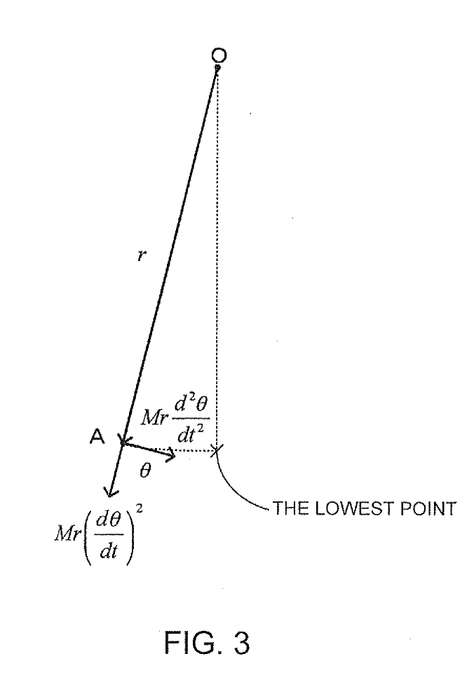

FIG. 3 shows the acceleration acting on a diaphragm 24. Now, assuming the grip 12a (the portion gripped with hands) as the center O, and denoting the distance from the center O to the center position A of the diaphragm 24 of the speed detector 10 attached to the golf head 12d as “r,” the direction (the direction of the movement) of the swing as “θ,” and the mass of the diaphragm 24 as “M,” the acceleration in the direction of the movement of the golf head 12d is expressed as M·r·d²θ/dt², and the acceleration in the longitudinal direction 12c (the r direction) of the shaft 12b is expressed as M·r·(dθ/dt)². Here, in the case with the golf club 12, it is ideal that the golf ball is hit when the golf head 12d reaches the lowest point, and at the same time, the speed of the golf head 12d becomes the maximum at the lowest point. In this case, since de/dt becomes maximum, and at the same takes an extremal value, d²θ/dt² becomes zero. Therefore, it seems that the acceleration in the direction of θ does not exist at the lowest point. However, in reality, since it result that the component in the direction (the direction of θ) of the movement of the golf head 12d appears also at the lowest point depending on the skill of the player, by disposing the pressure sensor 20 as in the present embodiment, the speed thereof in the direction of θ can be obtained while preventing the acceleration component in the direction of θ from being detected.

The operation section 28 calculates the variation in the pressure inside the container based on the variation in the resonant frequency of the oscillation signal output from the pressure sensor 20, and then calculates the speed of the golf head 12d based on the variation in the pressure. Specifically, the speed of the golf head 12d is calculated based on the difference between the pressure the pressure sensor 20 detects when the golf head 12d rests for a predetermined period of time at the lowest point and the pressure at the characteristic point the pressure sensor 20 detects when the golf head 12d is in movement. Here, the characteristic point denotes a time point corresponding to the maximum value (in most cases, the pressure becomes maximum at the lowest point) of the pressure measured when swinging the golf club 12, or a time point at which a discontinuous change in the pressure caused at the moment of hitting the golf ball with the golf club 12 occurs.

The operation section 28 is required to be electrically connected to the excitation electrode (not shown) of the pressure sensor 20, but does not have any restriction on the position in the arrangement. Therefore, it is possible for the operation section 28 to be disposed outside the golf club 12, and connected to a cable 30, which is connected to the excitation electrode (not shown) and inserted in the shaft 12b and the grip 12a, for example. Further, it is assumed that the operation section 28 measures the resonant frequency every predetermined period of time, and is able to display the temporal variation thereof on the display as a graph. Further, the operation section 28 has a program configured so that the pressure can be calculated using a polynomial in the oscillation frequency thus measured and coefficients thereof. Further, the program of the operation section 28 is configured so as to calculate the dynamic pressure from the difference between the pressure ((static pressure)+(dynamic pressure)) obtained by converting the oscillation frequency when the golf head 12d is in movement and the pressure (static pressure) obtained by converting the oscillation frequency when the golf head 12d is at rest, and then calculate the speed of the golf head using Formula 2. It should be noted that it is assumed that a temperature sensor (not shown) connected to the operation section 28 via the cable 30 is disposed inside the container 14, and the operation section 28 has a configuration of performing temperature compensation on the oscillation frequency of the oscillation signal input from the pressure sensor 20 based on the temperature data thus input.

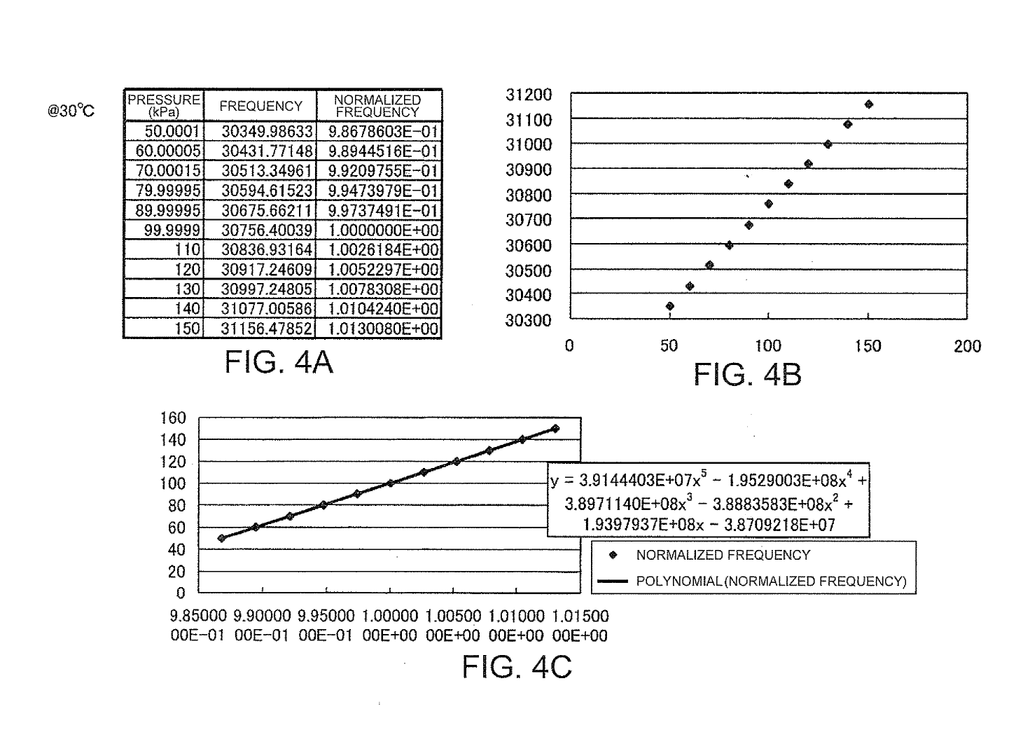

FIGS. 4A through 4C show relationship between the frequency of the pressure sensor 20 and the pressure. FIG. 4A is a table showing relationships (at measuring temperature of 30° C.) between the pressure, the frequency, and a normalized frequency, FIG. 4B is a plot chart showing the relationship between the pressure and the frequency, and FIG. 4C is a chart showing dots representing the relationship between the pressure and the frequency fitted with a polynomial expression. The oscillation frequency of the pressure sensor 20 varies in accordance with the pressure from the outside as described above. Therefore, when calculating the pressure based on the oscillation frequency in the operation section 28, the following operation is previously performed using an external PC or the like. Firstly, the oscillation frequency of the pressure sensor 20 is normalized by a predetermined frequency, and the relationship between the oscillation frequency and the pressure is plotted within a pressure range assumed in the pressure sensor 20. Further, as shown in FIG. 4C, denoting the variable of the frequency as x, and the variable of the pressure, which is a function of the variable x, as y, the coordinates of the polynomial expression (power series) of the oscillation frequency fitted to these points plotted thereon are calculated using simultaneous linear equations with multiple unknowns, and then the coordinates thus obtained are stored in a storage area (not shown) of the operation section 28. Thus, when measuring the oscillation frequency of the oscillation signal of the pressure sensor 20, the operation section 28 can retrieve the coordinates from the storage area (not shown), and then substitutes the coordinates into the polynomial expression of the oscillation frequency, thereby obtaining the pressure.

In the present embodiment, the pressure measured by the pressure sensor 20 varies in accordance with the variation in atmospheric pressure caused by the variation in the heightwise position. Therefore, it is not achievable to measure the pressure at the lowest point of the golf head 12d at a different heightwise position. Further, it is not achievable to simultaneously measure the pressure (static pressure) when the golf head 12d is at rest at the lowest point and the pressure ((dynamic pressure)+(static pressure)) at the lowest point of the golf head 12d when performing the SWING with the golf club 12. Incidentally, in the procedure of the SWING with the golf club 12, the golf head 12d is stopped at the lowest point of the golf head 12d, namely the position for hitting the golf ball, for several seconds (an address operation), then the golf head 12d is taken back toward the opposite direction to the direction (the direction of the movement) in which the golf ball is hit to fly, and then the golf head 12d is swung in the direction of the movement so as to pass through the lowest point. Here, since it is possible to assume that the variation in the heightwise position hardly occurs during the period of performing the address operation, the static pressure at the lowest point can be measured at the stage of the address operation.

Therefore, in the operation section 28 the program is configured so as to set the time point at which the oscillation frequency takes the maximum value after the player starts the swing as the time point at which the golf head 12d passes through the lowest point, calculate the maximum value of the pressure ((dynamic pressure)+(static pressure)) in movement based on the maximum value of the oscillation frequency, extract the period of time in which the variation in the oscillation frequency stays within a predetermined range for a predetermined time of a few seconds prior to the time point, obtain the pressure at rest based on the oscillation frequency (besides the average value of the oscillation frequency in this period of time, the highest value or the lowest value can also be adopted) in this period of time, then calculate the dynamic pressure by subtracting the pressure at rest from the maximum value of the pressure in movement, and then obtain the speed of the golf head 12d (the speed detector 10) based on the dynamic pressure.

Further, the present embodiment can be used not only in the SWING with the golf club 12, but also in actually hitting the golf ball with the golf club 12. In this case, since the oscillation frequency of the oscillation signal output from the pressure sensor 20 at the moment of hitting the golf ball with the golf head 12d shows discontinuous values, it is possible for the operation section 28 to extract the pressure immediately before the discontinuous value appears, and to obtain the swing speed based on the difference between the pressure thus extracted and the pressure at rest.

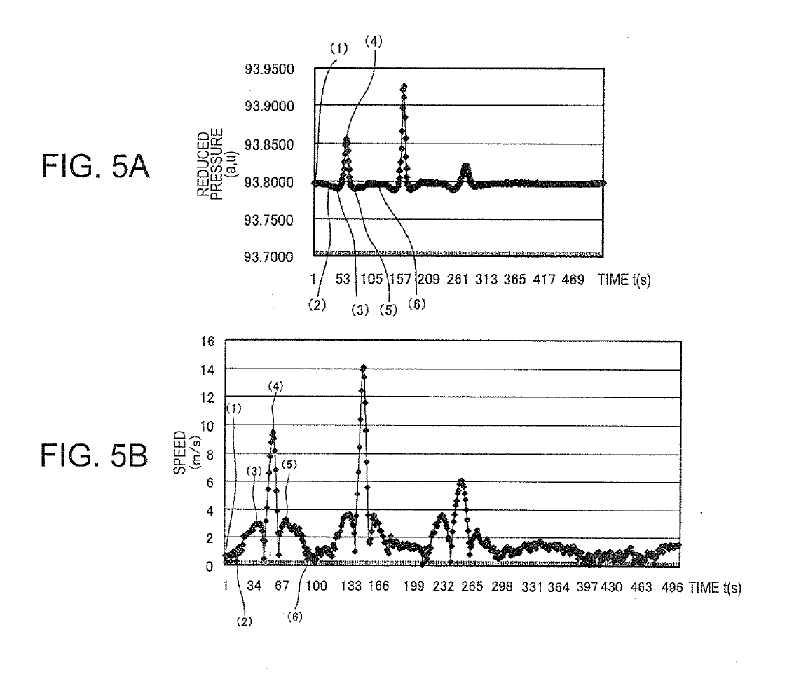

FIGS. 5A and 5B show a graph representing the pressure measured by the operation section 28 and the speed of the moving body (the golf head 12d). FIG. 5A is a graph showing the pressure measured by the operation section 28, and FIG. 5B is a graph showing the speed of the moving body (the golf head 12d) obtained from the pressure thus measured. In FIGS. 5A and 5B, the golf club 12 was swung three times. As a series of operations of the golf club 12, there can be cited (1) address operation (initial position) at the lowest point, (2) take back, (3) stop at a take-back position, (4) swing passing through the lowest point, (5) stop at the end of the swing, (6) movement for returning the initial position. As shown in FIG. 5A, in the operation (1), since the golf head 12d (the speed detector 10) is located at the lowest point (the initial position), the golf head 12d has a predetermined frequency and the measured pressure corresponding thereto. Then, when taking back and the stopping the golf head 12d as in the operations (2) and (3), the measured pressure is reduced since the position of the pitot tube 16 is raised, and the oscillation frequency is lowered in accordance therewith. Then, by making the swing as in the operation (4), the air flows into the pitot tube 16, and therefore, the dynamic pressure is added to the measured pressure of the pitot tube 16 to raise the oscillation frequency, and then the measured pressure and the oscillation frequency reach respective peaks when the golf head 12d reaches the highest speed at the lowest point, and then the values of the both parties are lowered after passing the respective peaks. Then, in the operation (5), since the swing is completed, no dynamic pressure exists, and the measured pressure becomes in a low state since the pitot tube 16 comes the high position similarly to the case of the operation (3), and the measured pressure returns to the state of the operation (1) by returning the golf head 12d to the lowest point in the operation (6). Since the measured pressure is obtained as described above, the speed of the golf head 12d can be obtained as shown in FIG. 5B assuming the pressure when the golf head 12d is at rest at the lowest point as the reference pressure. It should be noted that in FIG. 5B, the right side of Formula 2 is bracketed with a root sign, and is unable to be calculated if the measured pressure P₁ takes a value lower than the reference pressure P₂, and therefore, it is calculated using the absolute value of the difference between the measured pressure and the reference pressure.

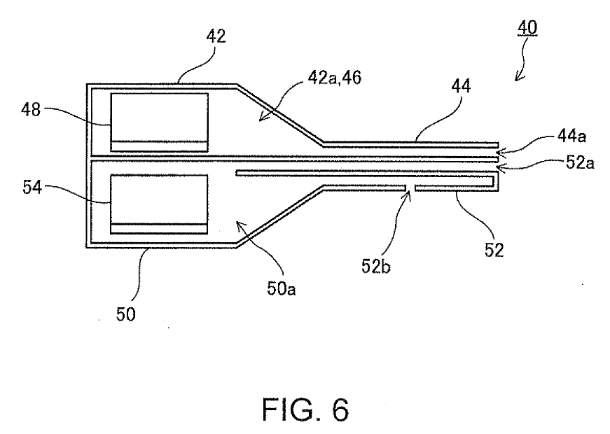

FIG. 6 shows a speed detector according to a second embodiment. The speed detector according to the second embodiment has a container 42 attached to the moving body and having an opening section 42a, a first pressure sensor 48 disposed inside the container 42, provided with a pitot tube 44 attached to the opening section 42a in the state of having an air inlet hole 44a directed toward the direction of the movement of the moving body to form an internal space 46 integrally with the container 42, and having the pressure in the internal space 46 vary due to the movement of the moving body, a diaphragm having a pressure receiving surface displaced in accordance with the pressure, and a pressure-sensitive section for receiving the force caused by the displacement to detect the pressure, a second pressure sensor 54 disposed outside the internal space 46, and a second operation section (not shown) for detecting the speed of the moving body based on the difference between the pressure detected by the first pressure sensor 48 and the pressure detected by the second pressure sensor 54, and the pressure sensors 48, 54 are arranged so that the normal line of the pressure receiving surface becomes perpendicular to the direction of the movement.

The first pressure sensor 48 and the second pressure sensor 54 according to the second embodiment are the same as the pressure sensor 20 of the first embodiment, and are attached to the moving body in the same direction. Further, similarly to the pressure sensor 20 according to the first embodiment, the first pressure sensor 48 is disposed in the internal space 46 formed of the container 42 and the pitot tube 44, and is capable of detecting the pressure inside the internal space 46 in accordance with the speed of the air flowing into the air inlet hole 44a of the pitot tube 44. On the other hand, the second pressure sensor 54 is disposed in a second container 50 disposed outside the container 42, and a second pitot tube 52 for measuring the static pressure is coupled to the opening section 50a of the second container 50. The second pitot tube 52 is formed integrally with the first pitot tube 44, and has an air inlet hole 52a. However, since the second pitot tube 52 is further provided with a leak hole 52b, the pressure in the second container 50 is always equal to the static pressure irrespective of the speed of the air flowing into the air inlet hole 52a.

Therefore, in the second operation section (not shown), it becomes possible to measure the dynamic pressure by calculating the difference between the pressure ((dynamic pressure)+(static pressure)) obtained by converting the oscillation frequency measured by the first pressure sensor 48 and the pressure (static pressure) obtained by converting the oscillation frequency measured by the second pressure sensor 54. It should be noted that although the operation for converting the oscillation frequency measured into the pressure is performed also in the second operation section (not shown), since substantially the same operation as that of the operation section 28 in the first embodiment is performed, the explanation will be omitted.

As described above, according to the speed detector 10 related to the first embodiment, firstly, since the speed of the golf head 12d can be detected with a single pressure sensor 20, and at the same time, the normal line 24b of the pressure receiving surface 24a of the diaphragm 24 is arranged so as to be perpendicular to the direction of the movement of the golf head 12d, even if the acceleration in the direction of the movement is generated, the displacement of the pressure receiving surface 24a is not caused by the acceleration, and therefore, the pressure sensor 20 can be prevented from falsely detecting the acceleration in the direction of the movement as the pressure.

Secondly, by adopting the configuration of the second embodiment, it results that the pressure ((static pressure)+(dynamic pressure)) measured by the first pressure sensor 48 and the pressure (static pressure) measured by the second pressure sensor 54 are calculated simultaneously to calculate the dynamic pressure based on the difference between the both parties, and the speed of the golf head 12d is obtained based on the dynamic pressure thus obtained. Therefore, the speed of the golf head 12d can be measured without previously measuring the static pressure.

Thirdly, since the pitot tubes 16, 44 are each formed to have a tapered shape having the diameter decreasing toward the direction of the movement of the golf head 12d, it becomes possible to prevent the turbulent flow of the air caused by the pitot tubes 16, 44 in the outside of the pitot tubes 16, 44 to thereby reduce the interference to the movement of the golf head 12d.

Fourthly, the golf head 12d moves so that the acceleration in the direction perpendicular to the direction of the movement acts thereon, and at the same time, the pressure sensor 20 (48, 54) is arranged so that the normal line 24b of the pressure receiving surface 24a becomes perpendicular to the direction (the r direction) of the acceleration (centrifugal force). As the movement of receiving the acceleration in the direction perpendicular to the direction of the movement of the golf head 12d, a circular movement (swing) can be cited. Therefore, according to the configuration described above, it becomes possible to prevent the false detection of the acceleration caused when the golf head 12d performs the circular movement as the pressure to thereby measure the speed of the golf head 12d with high accuracy.

Fifthly, as described in the first embodiment, the operation section 28 is arranged to have a configuration of obtaining the speed of the golf head 12d from the difference between the pressure the pressure sensor 20 detects when the golf headrests for a predetermined period of time at the lowest point of the movement (swing) of the golf head 12d, and the pressure at the characteristic point the pressure sensor 20 detects when the golf head 12d is in movement (in the swing motion).

In the configuration described above, the characteristic point denotes the time point at which the pressure measured becomes the highest or the time point immediately before the pressure measured becomes discontinuous. The pressure measured by the pressure sensor 20 has the value varying in accordance with the atmospheric pressure when the heightwise position of the pressure sensor 20 varies. Further, in the golf head 12d performing the movement described above, since the speed at the lowest point becomes the highest, it is possible for the operation section 28 to detect it as a peak value. Further, the pressure when the golf head 12d is at rest previously measured at the lowest point, and the component of the static pressure in the pressure in movement (in the swing motion) when the golf head 12d passing through the lowest point become theoretically the same value. Therefore, according to the configuration described above, it is possible to obtain the dynamic pressure by subtracting the pressure at rest previously measured at the lowest point from the pressure in movement when the golf head 12d passing through the lowest point, and then obtain the speed of the golf head 12d at the lowest point based on the dynamic pressure. Further, the pressure the pressure sensor 20 detects at the moment the golf head 12d actually hit the ball becomes discontinuous. Therefore, by calculating the difference between the pressure at a time point prior to the moment the pressure becomes discontinuous and the pressure at rest described above, the speed of the golf head 12d can be obtained.

Sixthly, by configuring the golf club 12 making it possible to swing the speed sensor 10 described above attached to the golf head 12d, the golf club 12 capable of obtaining the speed of the golf head 12d without being affected by the acceleration acted on the golf head 12d is obtained.

It should be noted that although the description is presented assuming that the SWING tool and the moving body to which the speed detector 10 is attached is the golf head 12d in either of the embodiments, the invention is not limited thereto. It is also possible to attach the speed detector 10 to, for example, a frame or a string of a tennis racket, a baseball bat.

Further, although in either of the embodiments, the description is presented assuming that the pressure sensor applies the piezoelectric vibrator as the pressure-sensitive section 26, and detects the pressure based on the variation in the oscillation frequency of the piezoelectric vibrator due to the force applied by the diaphragm 24, the invention is not limited thereto. In other words, it is obvious that any pressure sensor using the diaphragm 24 such as a capacitance variation type, a piezoresistance variation type can widely be applied as the pressure-sensitive section besides the frequency variation type described above.

The entire disclosure of Japanese Patent Application No. 2009-232872, filed Oct. 6, 2009 and Japanese Patent Application No. 2010-167783, filed Jul. 27, 2010 is expressly incorporated by reference herein.

1. A speed detector comprising:
a pressure sensor including
a pitot tube attached to a moving body in a state in which an air inlet hole is directed toward a direction of a movement of the moving body,
a diaphragm having a pressure receiving surface displaced by pressure, and
a pressure-sensitive section adapted to receive force caused by the displacement to detect the pressure,
the pressure sensor being disposed to the moving body and detecting the pressure caused in the pitot tube; and
an operation section adapted to detect a speed of the moving body based on the difference between the pressure at rest and the pressure in movement of the moving body,
wherein the pressure sensor is disposed so that a normal line of the pressure receiving surface becomes perpendicular to the direction of the movement.

2. A speed detector comprising:
a container attached to a moving body and having an opening section;
a first pressure sensor disposed inside the container and including
a pitot tube attached to the opening section in the state of having an air inlet hole directed toward a direction of a movement of the moving body to form an internal space integrally with the container, and having pressure in the internal space vary due to the movement of the moving body,
a diaphragm having a pressure receiving surface displaced by the pressure, and
a pressure-sensitive section adapted to receive force caused by the displacement to detect the pressure;
a second pressure sensor disposed outside the internal space; and
a second operation section adapted to detect a speed of the moving body based on a difference between the pressure detected by the first pressure sensor and the pressure detected by the second pressure sensor,
wherein the first and the second pressure sensors are disposed so that a normal line of the pressure receiving surface becomes perpendicular to the direction of the movement.

3. The speed detector according to claim 1, wherein
the pitot tube has a tapered shape having a diameter decreasing toward the direction of the movement.

4. The speed detector according to claim 1, wherein
the moving body receives acceleration in a direction perpendicular to the direction of the movement, and the pressure sensor is disposed so that the normal line of the pressure receiving surface becomes perpendicular to the direction of the acceleration.

5. The speed detector according to claim 1, wherein
the moving body stops at a measured point for a predetermined period of time, and then moves so as to pass through the measured point, and
the operation section calculates the speed of the moving body based on a difference between the pressure the pressure sensor detects when the moving body stops at the measured point for the predetermined period of time, and the pressure the pressure sensor detects when the moving body is in movement.

6. A SWING tool comprising:
the speed detector according to claim 1 attached.

7. The speed detector according to claim 3, wherein
the moving body receives acceleration in a direction perpendicular to the direction of the movement, and the pressure sensor is disposed so that the normal line of the pressure receiving surface becomes perpendicular to the direction of the acceleration.

8. The speed detector according to claim 3, wherein
the moving body stops at a measured point for a predetermined period of time, and then moves so as to pass through the measured point, and
the operation section calculates the speed of the moving body based on a difference between the pressure the pressure sensor detects when the moving body stops at the measured point for the predetermined period of time, and the pressure the pressure sensor detects when the moving body is in movement.

9. The speed detector according to claim 4, wherein
the moving body stops at a measured point for a predetermined period of time, and then moves so as to pass through the measured point, and
the operation section calculates the speed of the moving body based on a difference between the pressure the pressure sensor detects when the moving body stops at the measured point for the predetermined period of time, and the pressure the pressure sensor detects when the moving body is in movement.

10. A SWING tool comprising:
the speed detector according to claim 3 attached.

11. A SWING tool comprising:
the speed detector according to claim 4 attached.

12. A SWING tool comprising:
the speed detector according to claim 5 attached.

13. A SWING tool comprising:
the speed detector according to claim 7 attached.

14. A SWING tool comprising:
the speed detector according to claim 8 attached.

15. A SWING tool comprising:
the speed detector according to claim 9 attached.
